(19) United States
(12) Patent Application Publication
(10) Pub. No.: US 2022/0178719 A1
(43) Pub. Date: Jun. 9, 2022

(54) SYSTEMS AND METHODS FOR POSITIONING A TARGET SUBJECT

(71) Applicant: BEIJING VOYAGER TECHNOLOGY CO., LTD., Beijing (CN)

(72) Inventors: Baohua ZHU, Beijing (CN); Shengsheng HAN, Beijing (CN); Xiaozhi QU, Beijing (CN); Tingbo HOU, Mountain View, CA (US)

(73) Assignee: BEIJING VOYAGER TECHNOLOGY CO., LTD., Beijing (CN)

(21) Appl. No.: 17/651,901

(22) Filed: Feb. 22, 2022

Related U.S. Application Data
(63) Continuation of application No. PCT/CN2019/102831, filed on Aug. 27, 2019.

(51) Int. Cl. G01C 21/00

(52) U.S. Cl. CPC G01C 21/3867; G01C 21/387

(57) ABSTRACT

The present disclosure relates to systems and methods for determining a target position of a target subject. The method may include determining, via a positioning device, an initial position of a target subject in real-time. The method may also include determining, via a data capturing device, first data indicative of a first environment associated with the initial position of the target subject and determining a first map based on the first data indicative of the first environment. The first map may include reference feature information of at least one reference object with respect to the first environment. The method may also include determining a target position of the target subject based on the initial position, the first map, and a second map in real-time. The second map may include second data indicative of a second environment corresponding to an area including the initial position of the target subject.

### CROSS-REFERENCE TO RELATED APPLICATIONS

This application is a continuation of International Patent Application No. PCT/CN2019/102831, filed on Aug. 27, 2019, the contents of which are hereby incorporated by reference.

### TECHNICAL FIELD

The present disclosure generally relates to systems and methods for positioning a target subject, and in particular, to systems and methods for positioning the target subject using real-time map data collected by positioning sensors and pre-generated high-definition map data.

### BACKGROUND

A current platform may combine the GPS with other positioning sensors to position a subject (e.g., a moving vehicle, an office building), for example, an Inertial Measurement Unit (IMU). The GPS normally provides the location of the subject in longitude and latitude of the subject. The IMU can provide an attitude of the subject (e.g., a yaw angle, a pitch angle, a roll angle). However, in situations such as positioning and navigating an autonomous vehicle, the positioning accuracy of the GPS/IMU (e.g., at meter level, or at decimeter level) is not high enough. Since a positioning accuracy of a high-definition map can reach a centimeter level, the present disclosure uses the GPS/IMU and the high-definition map cooperatively to position the subject, thereby improving the positioning accuracy. Therefore, it is desirable to provide systems and methods for automatically positioning the target subject using the GPS/IMU and the high-definition map with higher accuracy.

### SUMMARY

In one aspect of the present disclosure, a system for determining a target position of a target subject is provided. The system may include at least one storage medium and at least one processor in communication with the at least one storage medium. The at least one storage medium may include a set of instructions. When executing the set of instructions, the at least one processor may be directed to: determine, via a positioning device, an initial position of a target subject in real-time; determine, via a data capturing device, first data indicative of a first environment associated with the initial position of the target subject; determine a first map based on the first data indicative of the first environment, wherein the first map may include reference feature information of at least one reference object with respect to the first environment; and determine a target position of the target subject based on the initial position, the first map, and a second map in real-time, wherein the second map may include second data indicative of a second environment corresponding to an area including the initial position of the target subject.

In some embodiments, the reference object may include an object with a predetermined shape.

In some embodiments, the predetermined shape may include a rod shape, or a faceted shape.

In some embodiments, the first data may include a first point cloud indicative of the first environment, and the first point cloud includes data of a plurality of points, and to determine a first map based on the first data indicative of the first environment, the at least one processor may be further directed to: determine point feature information of each point in the first point cloud; determine a plurality of point clusters based on the point feature information and spatial information of each point in the first point cloud; and determine the first map based on the point feature information and the plurality of point clusters.

In some embodiments, the at least one processor may be further directed to: determine the point feature information based on a Principal Component Analysis (PCA).

In some embodiments, wherein to determine a plurality of point clusters based on the point feature information and spatial information of each point in the first point cloud, the at least one processor may be further directed to: filter out at least a portion of the plurality of points in the first point cloud based on the point feature information; and determine the plurality of point clusters based on point feature information of each of the filtered points and spatial information of each of the filtered points.

In some embodiments, the point feature information of each point in the first point cloud may include at least one of: a feature value of the point, a feature vector corresponding to the feature value of the point, a linearity of the point, a planarity of the point, a verticality of the point, or a scattering value of the point.

In some embodiments, for each two points in each of the plurality of point clusters, wherein: a difference between feature information of the two points may be smaller than a first predetermined threshold; and a difference between spatial information of the two points may be smaller than a second predetermined threshold.

In some embodiments, wherein to determine the first map based on the point feature information and the plurality of point clusters, the at least one processor may be directed to: determine cluster feature information of each of at least one point cluster corresponding to one of the at least one reference object among the plurality of point clusters; and determine the first map based on the point feature information, the cluster feature information and the at least one point cluster.

In some embodiments, wherein to determine cluster feature information of each of at least one point cluster corresponding to one of the at least one reference object among the plurality of point clusters, the at least one processor may be directed to: determine a category of each of the plurality of point clusters based on a classifier; designate one point cluster of the plurality of point clusters as one of the at least one point cluster if a category of the point cluster is a same as a category of one of the at least one reference object; and determine the cluster feature information of the at least one point cluster.

In some embodiments, the cluster feature information of each of at least one point cluster may include at least one of: a category of each of the point cluster, an average feature vector of the point cluster, or a covariance matrix of each of the point cluster.

In some embodiments, the classifier may include a random forest classifier.

In some embodiments, the reference feature information of the at least one reference object with respect to the first environment may include at least one of: a reference category of the reference object, a reference feature vector corresponding to the reference object, or a reference covariance matrix of the reference object, or the at least one processor may determine the reference feature information based on the cluster feature information.

In some embodiments, the at least one processor may be further directed to: label the first map with the cluster feature information of each of the at least one cluster.

In some embodiments, the second map may include a plurality of second sub maps corresponding to the at least one reference object, and to determine a target position of the target subject based on the initial position, the first map, and a second map in real-time, the at least one processor may be directed to: set a reference position as a position corresponding to the initial position in the second map; determine at least one second sub map matched with the at least one first sub map based on the initial position and the reference position among the plurality of second sub maps; determine a function of the reference position, wherein the function of the reference position may represent a match degree between the at least one first sup map and the at least one second sub map; and designate a reference position with a highest value of the function as the target position.

In some embodiments, for one first sub map of the at least one first sub map and a second sub map matched with the first sub map, wherein: a category of a reference object corresponding to the second sub map may be the same as a category of a reference object corresponding to the first sub map, and a distance between a converted first sup map and the second sub map may be smaller than a predetermined distance threshold, wherein the converted first sub map may be generated by converting the first sub map into the second map based on the reference position and the initial position.

In some embodiments, the at least one processor may determine the reference position with the highest value based on a Newton iterative algorithm.

In some embodiments, the positioning device may include a Global Positioning System (GPS) and an Inertial Measurement Unit (IMU).

In some embodiments, the GPS and the IMU may be respectively mounted on the target subject.

In some embodiments, the initial position may include a location of the target subject and an attitude of the target subject.

In some embodiments, the data capturing device may include Lidar.

In some embodiments, the Lidar may be mounted on the target subject.

In some embodiments, the target subject may include an autonomous vehicle.

In some embodiments, the at least one processor may be directed to: transmit a message to a terminal, directing the terminal to display the target position of the target subject on a user interface of the terminal in real-time.

In some embodiments, the at least one processor may be directed to: provide a navigation service to the target subject based on the target position of the target subject in real-time.

In another aspect of the present disclosure, a method for determining a target position of a target subject is provided. The method may be implemented on a computing device having at least one processor, at least one storage medium, and a communication platform connected to a network. The method may include determining, via a positioning device, an initial position of a target subject in real-time; determining, via a data capturing device, first data indicative of a first environment associated with the initial position of the target subject; determining a first map based on the first data indicative of the first environment, wherein the first map may include reference feature information of at least one reference object with respect to the first environment; and determining a target position of the target subject based on the initial position, the first map, and a second map in real-time, wherein the second map may include second data indicative of a second environment corresponding to an area including the initial position of the target subject.

In some embodiments, the reference object may include an object with a predetermined shape.

In some embodiments, the predetermined shape may include a rod shape, or a faceted shape.

In some embodiments, the first data may include a first point cloud indicative of the first environment, and the first point cloud may include data of a plurality of points, and determining a first map based on the first data indicative of the first environment may include: determining point feature information of each point in the first point cloud; determining a plurality of point clusters based on the point feature information and spatial information of each point in the first point cloud; and determining the first map based on the point feature information and the plurality of point clusters.

In some embodiments, the method may further include determining the point feature information based on a Principal Component Analysis (PCA).

In some embodiments, wherein determining a plurality of point clusters based on the point feature information and spatial information of each point in the first point cloud includes: filtering out at least a portion of the plurality of points in the first point cloud based on the point feature information; and determining the plurality of point clusters based on point feature information of each of the filtered points and spatial information of each of the filtered points.

In some embodiments, wherein the point feature information of each point in the first point cloud may include at least one of: a feature value of the point, a feature vector corresponding to the feature value of the point, a linearity of the point, a planarity of the point, a verticality of the point, or a scattering value of the point.

In some embodiments, for each two points in each of the plurality of point clusters, wherein: a difference between feature information of the two points is smaller than a first predetermined threshold; and a difference between spatial information of the two points is smaller than a second predetermined threshold.

In some embodiments, wherein determining the first map based on the point feature information and the plurality of point clusters may include: determining cluster feature information of each of at least one point cluster corresponding to one of the at least one reference object among the plurality of point clusters; and determining the first map based on the point feature information, the cluster feature information and the at least one point cluster.

In some embodiments, wherein determining cluster feature information of each of at least one point cluster corresponding to one of the at least one reference object among the plurality of point clusters may include: determining a category of each of the plurality of point clusters based on a classifier; designating one point cluster of the plurality of point clusters as one of the at least one point cluster if a category of the point cluster is a same as a category of one of the at least one reference object; and determining the cluster feature information of the at least one point cluster.

In some embodiments, the cluster feature information of each of at least one point cluster may include at least one of: a category of each of the point cluster, an average feature vector of the point cluster, or a covariance matrix of each of the point cluster.

In some embodiments, the classifier may include a random forest classifier.

In some embodiments, the reference feature information of the at least one reference object with respect to the first environment may include at least one of: a reference category of the reference object, a reference feature vector corresponding to the reference object, or a reference covariance matrix of the reference object, or the reference feature information is determined based on the cluster feature information.

In some embodiments, the method may also include labelling the first map with the cluster feature information of each of the at least one cluster.

In some embodiments, the second map may include a plurality of second sub maps corresponding to the at least one reference object, and determining a target position of the target subject based on the initial position, the first map, and a second map in real-time includes: setting a reference position as a position corresponding to the initial position in the second map; determining at least one second sub map matched with the at least one first sub map based on the initial position and the reference position among the plurality of second sub maps; determining a function of the reference position, wherein the function of the reference position may represent a match degree between the at least one first sup map and the at least one second sub map; and designating a reference position with a highest value of the function as the target position.

In some embodiments, for one first sub map of the at least one first sub map and a second sub map matched with the first sub map, wherein: a category of a reference object corresponding to the second sub map may be the same as a category of a reference object corresponding to the first sub map, and a distance between a converted first sup map and the second sub map may be smaller than a predetermined distance threshold, wherein the converted first sub map may be generated by converting from the first sub map into the second map based on the reference position and the initial position.

In some embodiments, wherein the reference position with the highest value may be determined based on a Newton iterative algorithm.

In some embodiments, the positioning device may include a Global Positioning System (GPS) and an Inertial Measurement Unit (IMU).

In some embodiments, the GPS and the IMU may be respectively mounted on the target subject.

In some embodiments, the initial position may include a location of the target subject and an attitude of the target subject.

In some embodiments, the data capturing device may include Lidar.

In some embodiments, the Lidar may be mounted on the target subject.

In some embodiments, the target subject may include an autonomous vehicle.

In some embodiments, the method may also include transmitting a message to a terminal, directing the terminal to display the target position of the target subject on a user interface of the terminal in real-time.

In some embodiments, the method may also include providing a navigation service to the target subject based on the target position of the target subject in real-time.

In another aspect of the present disclosure, a non-transitory computer readable medium for determining a target position of a target subject is provided. The non-transitory computer readable medium, including executable instructions that, when executed by at least one processor, may direct the at least one processor to perform a method. The method may include determining, via a positioning device, an initial position of a target subject in real-time; determining, via a data capturing device, first data indicative of a first environment associated with the initial position of the target subject; determining a first map based on the first data indicative of the first environment, wherein the first map may include reference feature information of at least one reference object with respect to the first environment; and determining a target position of the target subject based on the initial position, the first map, and a second map in real-time, wherein the second map may include second data indicative of a second environment corresponding to an area including the initial position of the target subject.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary positioning system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process for determining a target position of a target subject according to some embodiments of the present disclosure;

FIG. 6 is a flowchart illustrating an exemplary process for determining a first map based on first data indicative of the first environment according to some embodiments of the present disclosure; and

FIG. 7 is a flowchart illustrating an exemplary process for determining a target position of a target subject based on an initial position of the target subject, a first map and a second map according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for determining a target position of a target subject in real-time. The system may determine an initial position of the target subject in real-time via a positioning device (e.g., a GPS/IMU). The system may also determine a first map including first data indicative of a first environment associated with the initial position of the target subject in real-time. In addition, the system may predetermine a high-definition map including second data indicative of a second environment corresponding to an area including the initial position of the target subject. The system may determine the target position of the target subject by matching the first map and the high-definition map based on the initial position.

According to the present disclosure, since the positioning accuracy of the high-definition map is higher than the positioning accuracy of the GPS/IMU, the positioning accuracy achieved by combining the GPS/IMU and the high-definition map may be improved comparing to a positioning platform that only uses the GPS/IMU.

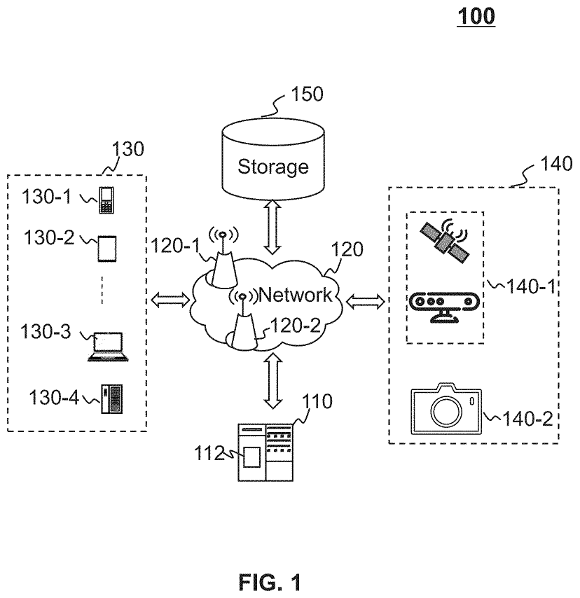

FIG. 1 is a schematic diagram illustrating an exemplary positioning system according to some embodiments of the present disclosure. The positioning system 100 may include a server 110, a network 120, a terminal device 130, a positioning engine 140, and a storage 150.

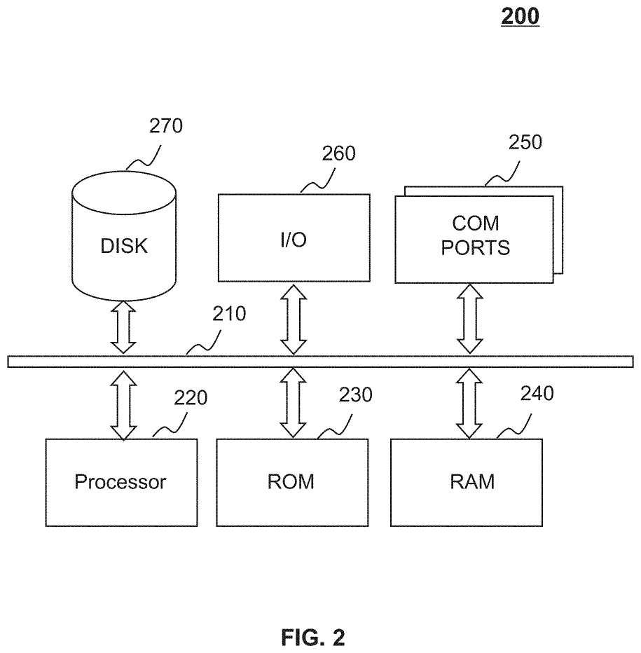

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the terminal device 130, the positioning engine 140, and/or the storage 150 via the network 120. As another example, the server 110 may be directly connected to the terminal device 130, the positioning engine 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2.

In some embodiments, the server 110 may include a processing engine 112. The processing engine 112 may process information and/or data to perform one or more functions described in the present disclosure. For example, the processing engine 112 may determine a first map based on first data indicative of a first environment associated with the initial position of the target subject. In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the positioning system 100 (e.g., the server 110, the terminal device 130, the positioning engine 140, or the storage 150) may transmit information and/or data to other component(s) of the positioning system 100 via the network 120. For example, the server 110 may obtain first data indicative of a first environment associated with a position of a subject (e.g., a vehicle) from the positioning engine 140 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the positioning system 100 may be connected to the network 120 to exchange data and/or information.

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc.

In some embodiments, the terminal device 130 may communicate with other components (e.g., the server 110, the positioning engine 140, the storage 150) of the positioning system 100. For example, the server 110 may transmit a target position of a target subject to the terminal device 130. The terminal device 130 may display the target position on a user interface (not shown in FIG. 1) of the terminal device 130. As another example, the terminal device 130 may transmit an instruction and control the server 110 to perform the instruction.

As shown in FIG. 1, the positioning engine 112 may at least include a positioning device 140-1 and a data capturing device 140-2. The positioning device 140-1 may be mounted and/or fixed on the target subject. The positioning device 140-1 may determine first position data of the target subject. The positioning data may include a location corresponding to the target subject and an attitude corresponding to the target subject. The location may refer to an absolute location of the target subject in a spatial space (e.g., the world) denoted by longitude and latitude information. The attitude may refer to an orientation of the target subject with respect to an inertial frame of reference such as a horizontal plane, a vertical plane, a plane of a motion of the target subject or another entity such as nearby objects. The attitude may include a yaw angle of the target subject, a pitch angle of the target subject, a roll angle of the target subject, etc.

In some embodiments, the positioning device 140-1 may include different types of positioning sensors. The different types of positioning sensors may be respectively mounted and/or fixed on a point of the target subject. In some embodiments, one or more positioning sensors may be integrated into the target subject. In some embodiments, the positioning device 140-1 may include a first positioning sensor that can determine an absolute location of the target subject and a second positioning sensor that can determine an attitude of the target subject. Merely by way of example, the first positioning sensor may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. The second positioning sensor may include an Inertial Measurement Unit (IMU). In some embodiments, the IMU may include at least one motion sensor and at least one rotation sensor. The at least one motion sensor may determine a linear accelerated velocity of the target subject, and the at least one rotation sensor may determine an angular velocity of the target subject. The IMU may determine the attitude of the target subject based on the linear accelerated velocity and the angular velocity. For illustration purpose, the IMU may include a Platform Inertial Measurement Unit (PIMU), a Strapdown Inertial Measurement Unit (SIMU), etc.

For illustration purpose, the positioning device 140-1 may include the GPS and the IMU (also referred to as “GPS/IMU”). In some embodiments, the GPS and/or the IMU may be integrated to the target subject. In some embodiments, the GPS may be respectively mounted and/or fixed on the target subject. The GPS may determine the location of the target subject and the IMU may determine the attitude of the target subject.

In some embodiments, the data capturing device 140-2 may be mounted on the target subject. In some embodiments, the data capturing device 140-2 may be Lidar. The Lidar may capture first data indicative of a first environment associated with the initial position of the target subject, e.g., from the initial position of the target subject. In some embodiments, the first data may include a point cloud associated with the first environment. The point cloud may represent the first environment in a three dimension.

The storage 150 may store data and/or instructions. In some embodiments, the storage 150 may store data obtained from the server 110, the terminal device 130 and/or the positioning engine 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the positioning system 100 (e.g., the server 110, the terminal device 130, the positioning engine 140). One or more components of the positioning system 100 may access the data and/or instructions stored in the storage 150 via the network 120. In some embodiments, the storage 150 may be directly connected to or communicate with one or more components of the positioning system 100 (e.g., the server 110, the terminal device 130, the positioning engine 140). In some embodiments, the storage 150 may be part of the server 110.

One of ordinary skill in the art would understand that when an element (or component) of the positioning system 100 performs, the element may perform through electrical signals and/or electromagnetic signals. For example, when the terminal device 130 transmits out an instruction to the server 110, a processor of the terminal device 130 may generate an electrical signal encoding the request. The processor of the terminal device 130 may then transmit the electrical signal to an output port. If the terminal device 130 communicates with the server 110 via a wired network, the output port may be physically connected to a cable, which further may transmit the electrical signal to an input port of the server 110. If the terminal device 130 communicates with the server 110 via a wireless network, the output port of the terminal device 130 may be one or more antennas, which convert the electrical signal to electromagnetic signal. Within an electronic device, such as the terminal device 130, the positioning engine 140, and/or the server 110, when a processor thereof processes an instruction, transmits out an instruction, and/or performs an action, the instruction and/or action is conducted via electrical signals. For example, when the processor retrieves or saves data from a storage medium (e.g., the storage 150), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 according to some embodiments of the present disclosure. In some embodiments, the server 110, and/or the terminal device 130 may be implemented on the computing device 200. For example, the processing engine 112 may be implemented on the computing device 200 and configured to perform functions of the processing engine 112 disclosed in this disclosure.

The computing device 200 may be used to implement any component of the positioning system 100 as described herein. For example, the processing engine 112 may be implemented on the computing device 200, via its hardware, software program, firmware, or a combination thereof. Although only one such computer is shown, for convenience, the computer functions as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

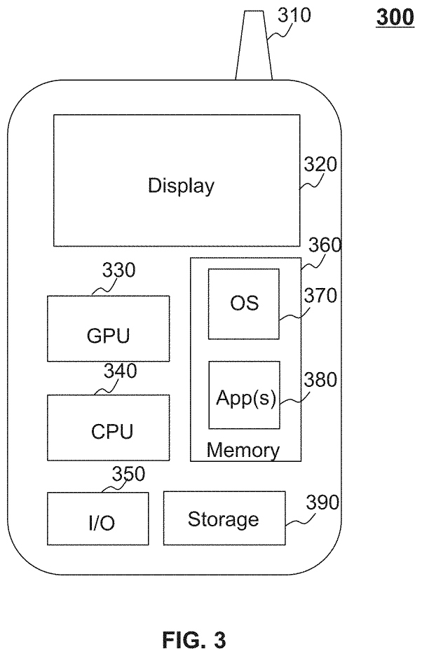

FIG. 3 is a schematic diagram illustrating exemplary hardware and/or software components of a mobile device 300 on which the terminal device 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information from the positioning system 100. User interactions with the information stream may be achieved via the I/O 350 and provided to the processing engine 112 and/or other components of the positioning system 100 via the network 120.

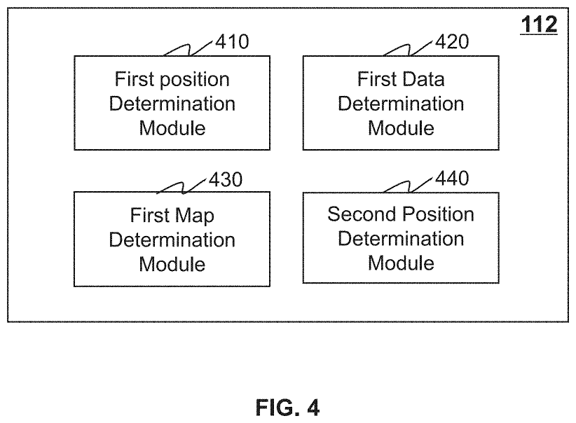

FIG. 4 is a block diagram illustrating an exemplary processing engine according to some embodiments of the present disclosure. The processing engine 112 may include a first position determination module 410, a first data determination module 420, a first map determination module 430, and a second position determination module 440.

The first position determination module 410 may be configured to determine, via a positioning device (e.g., the positioning device 140-1), an initial position of a target subject in real-time. As used herein, the target subject may be any subject that needs to be positioned. As used herein, the initial position of the target subject may refer to a position corresponding to a target point of the target subject. In some embodiments, the first positioning module 410 may predetermine similar points (e.g., centers) as target points for different target subjects. In some embodiments, the first positioning module 410 may predetermine different points as target points for different target subjects. Merely by way of example, the target point may include a center of gravity of the target subject, a point where a positioning device (e.g., the positioning device 140-1) is mounted on the target subject, a point where a data capturing device (e.g., the data capturing device 140-2) is mounted on the target subject, etc.

In some embodiments, the first positioning determination module 410 may determine the initial position based on first position data determined by the positioning device, and a relation associated with the target point and a first point where the positioning device is mounted on the target subject. In some embodiments, the first positioning determination module 410 may determine the initial position by converting the first position according to a relation associated with the first point and the target point. Specifically, the first positioning determination module 410 may determine a converting matrix based on the relation associated with the first point and the target point. The first positioning determination module 410 may determine the converting matrix based on a translation associated with the first point and the target point and a rotation associated with the first point and the target point.

As used herein, the first positioning data may include a location corresponding to the first point and an attitude corresponding to the first point. The location may refer to an absolute location of a point (e.g., the first point) in a spatial space (e.g., the world) denoted by longitude and latitude information, and the absolute location may represent a geographic location of the point in the spatial space, i.e., longitude and latitude. The attitude may refer to an orientation of a point (e.g., the first point) with respect to an inertial frame of reference such as a horizontal plane, a vertical plane, a plane of a motion of the target subject or another entity such as nearby objects. The attitude corresponding to the first point may include a yaw angle of the first point, a pitch angle of the first point, a roll angle of the first point, etc. Accordingly, the initial position of the target subject (i.e., the target point) may include an initial location of the target subject (i.e., the target point) and an initial attitude of the target subject (i.e., the target point). The initial location may refer to an absolute location of the target subject in the spatial space i.e., longitude and latitude. The initial attitude may refer to an orientation of the target subject with respect to an inertial frame of reference such as a horizontal plane, a vertical plane, a plane of a motion of the target subject or another entity such as nearby objects.

The first data determination module 420 may be configured to may determine, via a data capturing device, first data indicative of a first environment associated with the initial position of the target subject. As used herein, the first environment may refer to an environment where the target subject is captured at the initial position. The first data may include data indicative of the first environment captured at the initial position. In a different application scenario, the first environment may include different types of objects. The different types of objects may have different shapes, e.g., a rod shape, a facet shape, etc. For illustration purpose, objects with the rod shape may include a road lamp, a telegraph pole, a tree, a traffic light, etc. Objects with the facet shape may include a traffic sign board, an advertisement board, a wall, etc.

In some embodiments, the data capturing device may be mounted on a fourth point of the target subject, and data captured by the data capturing device may be from a fourth position corresponding to the fourth point. As described above, the target point corresponding to the initial position may be the center of gravity of the target subject, the point where the positioning device is mounted on the target subject, the point where the data capturing device is mounted on the target subject (i.e., the fourth point), etc. The fourth point may be different from the target point or the same as the target point. In some embodiments, if the target point is the same as the fourth point, the initial position of the target subject may be a position corresponding to the fourth point, and the data from the fourth position may be the data from the initial position. In some embodiments, if the target point is different from the fourth point, since the target point and the fourth point may be fixed on the target subject, a difference between the initial position corresponding to target point and a fourth position corresponding to the fourth point may be negligible and the first data from the initial position and the data from the fourth position may be the same, the first data determination module 420 may designate the data from the fourth position as the first data from the initial position.

In some embodiments, the data capturing device may be Lidar. The Lidar may determine the first data by illuminating the first environment with a laser and measuring a reflected laser. In some embodiments, the first data may be represented as a point cloud corresponding to the first environment. As used herein, the point cloud may refer to a set of data points in a spatial space, and each data point may correspond to data of a point in the first environment. Merely by way of example, each data point may include location information of the point, color information of the point, intensity information of the point, texture information of the point, or the like, or any combination thereof. In some embodiments, the set of data points may represent feature information of the first environment. The feature information may include a contour of an object in the first environment, a surface of an object in the first environment, a size of an object in the first environment, or the like, or any combination thereof.

The first map determination module 430 may be configured to may determine a first map based on the first data indicative of the first environment. Firstly, the first map determination module 430 may determine feature information associated with the point cloud. The feature information may include point feature information of the set of points based on data of the set of points in the point cloud, cluster feature information of at least one point cluster corresponding to at least one reference object (e.g., an object with a rod shape, an object with a facet shape). As used herein, the point feature information of a point may represent a relationship between the point and points in a region included the point. In some embodiments, the region may be a sphere centered at the point. The relation may be associated with linearity, planarity, verticality and scattering of the point.

In some embodiments, the first map determination module 430 may determine a plurality of point clusters based on the point feature information. Points in each of the plurality of point clusters may satisfy a predetermined condition. Specifically, for each two points in each of the plurality of point clusters, a difference between feature information of the two points may be smaller than a first predetermined threshold, and a difference between spatial information of the two points may be smaller than a second predetermined threshold. The first predetermined threshold and/or the second predetermined threshold may be default settings of the positioning system 100, or may be adjusted based on real-time conditions.

Further, the first map determination module 430 may determine the at least one point cluster corresponding to one of the at least one reference object among the plurality of point clusters. In some embodiments, the first map determination module 430 may determine a category of each of the plurality of point clusters. The first map determination module 430 may determine the category based on a shape of each of the plurality of point clusters. For example, the category may include a rod shape, a facet shape, a shape other than the rod shape and the facet shape. Further, the first map determination module 430 may determine the at least one point cluster based on the categories. In some embodiments, a shape of the at least one point cluster may be the rod shape or the facet shape.

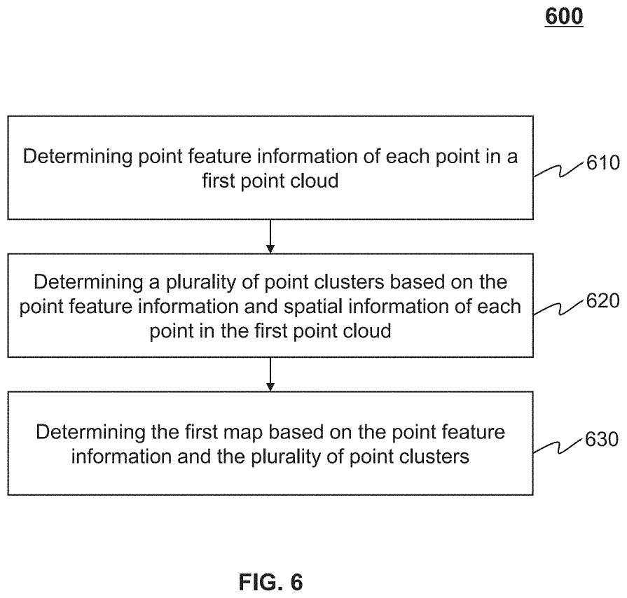

In some embodiments, the first map determination module 430 may determine the cluster feature information based on point feature information of the at least one point cluster. For illustrated purpose, the cluster feature information of a point cluster may include point feature information of points in the point cluster, a category of the point cluster, an average feature vector of the point cluster, a covariance matrix of each of the point cluster, etc. As used herein, the average feature vector may be an average of point feature vectors of points in the point cluster. More detailed description of determining the cluster feature information may be found elsewhere in the present disclosure. e.g., FIG. 6 and the description thereof.

Further, the first map determination module 430 may determine the first map based on the point cloud and the feature information associated with the point cloud. In some embodiments, the first map determination module 430 may convert the point cloud into the first map, and the first map may include the feature information associated with the point cloud. In some embodiments, the first map determination module 430 may label the first map with at least a portion of the feature information associated with the point cloud. Specifically, the first map determination module 430 may use the cluster feature information label the first map. In some embodiments, reference objects of different categories may be marked with different forms, e.g., colors, icons, texts, characters, numbers, etc. For example, the first map determination module 430 may label a reference object with a rod shape with a yellow color, and label a reference object with a facet shape with a blue color. As another example, the first map determination module 430 may label a reference object with a rod shape with a plurality of small circles, and label a facet shape with a plurality of small triangles.

The second position determination module 440 may be configured to determine a target position of the target subject based on the initial position, the first map, and a second map in real-time. As used herein, the second map may include second data indicative of a second environment corresponding to an area including the initial position of the target subject. For example, the area may include a district in a city, a region inside a beltway of a city, a town, a city, etc. In some embodiments, the second map may be predetermined by the positioning system 100 or a third party. The second position determination module 440 may obtain the second map from a storage device (e.g., the storage 150), such as the ones disclosed elsewhere in the present disclosure.

In some embodiments, the second position determination module 440 may determine the target position of the target subject by matching the first map and the second map. Specifically, the second position determination module 440 may determine a set of at least one second sub map in the second map that match the at least one first sub map based on the initial position. As used herein, each of the at least one second sub map may be a portion of the second map. The second position determination module 440 may determine a match degree between each of the set of at least one first sub map and the at least one second sub map. As used herein, the match degree may represent a similarity of the at least one first sub map and the at least one second map. In some embodiments, the second position determination module 440 may determine a maximum match degree, i.e., at least one second map corresponding to the maximum match degree may match the at least one first sub map best, and the second position determination module 440 may designate a position determined by the at least one second map as the target position of the target subject in the second map. Since a positioning accuracy of the second map is more accurate than a positioning accuracy of the GPS/IMU, the second position determination module 440 may determine a more accurate position (also referred to as “target position”) of the target subject by matching the first map and the second map based on the initial position.

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the first position determination module 410 and the second position determination module 460 may be combined as a single module which may both determine, via a positioning device, an initial position of a target subject in real-time and determine a target position of the target subject based on the initial position, a first map, and a second map in real-time. As another example, the processing engine 112 may include a storage module (not shown) which may be used to store data generated by the above-mentioned modules.

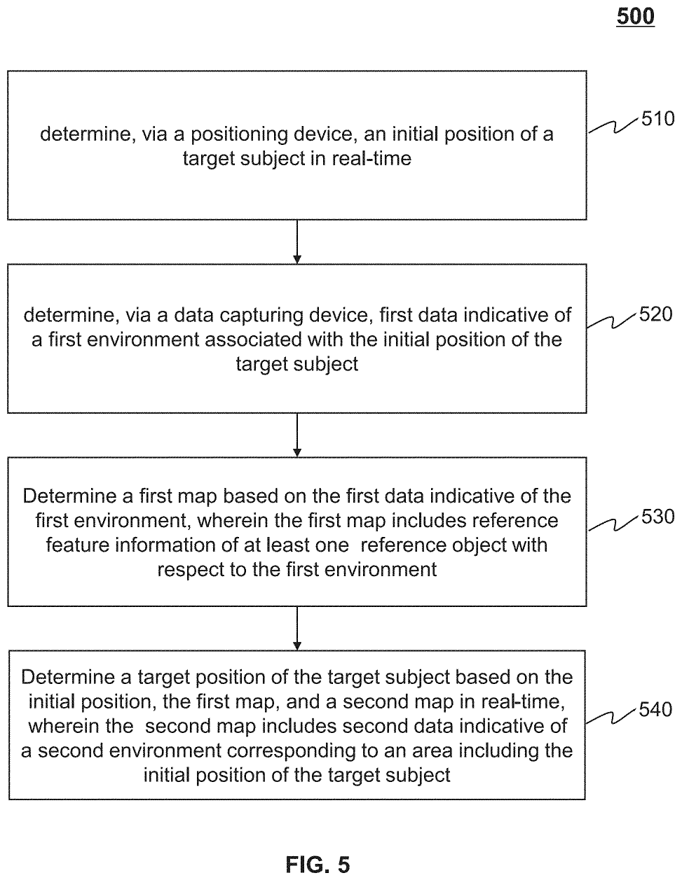

FIG. 5 is a flowchart illustrating an exemplary process for determining a target position of a target subject according to some embodiments of the present disclosure. In some embodiments, the process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 (e.g., the first position determination module 410 or the interface circuits of the processor 220) may determine, via a positioning device (e.g., the positioning device 140-1), an initial position of a target subject in real-time. As used herein, the target subject may be any subject that needs to be positioned. The target subject may exist in different application scenarios, e.g., land, ocean, aerospace, or the like, or any combination thereof. Merely by way of example, the target subject may include a manned vehicle, a semi-autonomous vehicle, an autonomous vehicle, a robot (e.g., a robot on road), etc. The vehicle may include a taxi, a private car, a hitch, a bus, a train, a bullet train, a high-speed rail, a subway, a vessel, an aircraft, a spaceship, a hot-air balloon, etc.

As used herein, the initial position of the target subject may refer to a position corresponding to a target point of the target subject. In some embodiments, the positioning system 100 may predetermine similar points (e.g., centers) as target points for different target subjects. In some embodiments, the positioning system 100 may predetermine different points as target points for different target subjects. Merely by way of example, the target point may include a center of gravity of the target subject, a point where a positioning device (e.g., the positioning device 140-1) is mounted on the target subject, a point where a data capturing device (e.g., the data capturing device 140-2) is mounted on the target subject, etc.

In some embodiments, as described in FIG. 1, the positioning device may be mounted and/or fixed on a first point of the target subject, and the positioning device may determine first position data of the first point. Further, the processing engine 112 may determine the initial position of the target subject based on the first positioning data. Specifically, since the first point and the target point are two fixed points of the target subject, the processing engine 112 may determine the initial position based on the first position, and a relation associated with the target point and the first point. In some embodiments, the processing engine 112 may determine the initial position by converting the first position according to the relation associated with the first point and the target point. Specifically, the processing engine 112 may determine a converting matrix based on the relation associated with the first point and the target point. The processing engine 112 may determine the converting matrix based on a translation associated with the first point and the target point and a rotation associated with the first point and the target point.

As used herein, the first positioning data may include a location corresponding to the first point and an attitude corresponding to the first point. The location may refer to an absolute location of a point (e.g., the first point) in a spatial space (e.g., the world) denoted by longitude and latitude information, and the absolute location may represent a geographic location of the point in the spatial space, i.e., longitude and latitude. The attitude may refer to an orientation of a point (e.g., the first point) with respect to an inertial frame of reference such as a horizontal plane, a vertical plane, a plane of a motion of the target subject or another entity such as nearby objects. The attitude corresponding to the first point may include a yaw angle of the first point, a pitch angle of the first point, a roll angle of the first point, etc. Accordingly, the initial position of the target subject (i.e., the target point) may include an initial location of the target subject (i.e., the target point) and an initial attitude of the target subject (i.e., the target point). The initial location may refer to an absolute location of the target subject in the spatial space i.e., longitude and latitude. The initial attitude may refer to an orientation of the target subject with respect to an inertial frame of reference such as a horizontal plane, a vertical plane, a plane of a motion of the target subject or another entity such as nearby objects.

In some embodiments, the positioning device may include different types of positioning sensors. The different types of positioning sensors may be respectively mounted and/or fixed on a point of the target subject. In some embodiments, one or more positioning sensors may be integrated into the target subject. In some embodiments, the positioning device may include a first positioning sensor that can determine an absolute location of the target subject (e.g., a point of the subject) and a second positioning sensor that can determine an attitude of the target subject. Merely by way of example, the first positioning sensor may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. The second positioning sensor may include an Inertial Measurement Unit (IMU). In some embodiments, the IMU may include at least one motion sensor and at least one rotation sensor. The at least one motion sensor may determine a linear accelerated velocity of the target subject, and the at least one rotation sensor may determine an angular velocity of the target subject. The IMU may determine the attitude of the target subject based on the linear accelerated velocity and the angular velocity. For illustration purpose, the IMU may include a Platform Inertial Measurement Unit (PIMU), a Strapdown Inertial Measurement Unit (SIMU), etc.

For illustration purpose, the positioning device may include the GPS and the IMU (also referred to as “GPS/IMU”). In some embodiments, the GPS and/or the IMU may be integrated into the target object. In some embodiments, the GPS may be mounted and/or fixed on a second point of the target subject and the IMU may be mounted and/or fixed on a third point of the target subject. Accordingly, the GPS may determine a second location of the second point and the IMU may determine a third attitude of the third point. Since the third point and the second point are two fixed points of the target subject, the processing engine 112 may determine a third location of the third point based on a difference (e.g. a location difference) between the second point and the third point. Further, as described above, the processing engine 112 may determine the initial position by converting a position of the third point (i.e., the third attitude and the third location) according to the relation associated with the third point and the target point. Specifically, the processing engine 112 may determine a converting matrix based on the relation associated with the third point and the target point. The processing engine 112 may determine the converting matrix based on a translation associated with the third point and the target point and a rotation associated with the third point and the target point.

In 520, the processing engine 112 (e.g., the first data determination module 420 or the interface circuits of the processor 220) may determine, via a data capturing device, first data indicative of a first environment associated with the initial position of the target subject. As used herein, the first environment may refer to an environment where the target subject is captured at the initial position. The first data may include data indicative of the first environment captured at the initial position. In a different application scenario, the first environment may include different types of objects. The different types of objects may have different shapes, e.g., a rod shape, a facet shape, etc. For illustration purpose, objects with the rod shape may include a road lamp, a telegraph pole, a tree, a traffic light, etc. Objects with the facet shape may include a traffic sign board, an advertisement board, a wall, etc.

In some embodiments, the data capturing device may be mounted on a fourth point of the target subject, and data captured by the data capturing device may be from a fourth position corresponding to the fourth point. As described above, the target point corresponding to the initial position may be the center of gravity of the target subject, the point where the positioning device is mounted on the target subject, the point where the data capturing device is mounted on the target subject (i.e., the fourth point), etc. The fourth point may be different from the target point or the same as the target point. However, the target point and the fourth point may be fixed on the target subject, and a difference between the initial position corresponding to target point and a fourth position corresponding to the fourth point may be negligible and the first data from the initial position and the data from the fourth position may be the same, the processing engine 112 may designate the data from the fourth position as the first data from the initial position.

In some embodiments, the data capturing device may be Lidar. The Lidar may determine the first data by illuminating the first environment with a laser and measuring a reflected laser. In some embodiments, the first data may be represented as a point cloud corresponding to the first environment. As used herein, the point cloud may refer to a set of data points in a spatial space, and each data point may correspond to data of a point in the first environment. Merely by way of example, each data point may include location information of the point, color information of the point, intensity information of the point, texture information of the point, or the like, or any combination thereof. In some embodiments, the set of data points may represent feature information of the first environment. The feature information may include a contour of an object in the first environment, a surface of an object in the first environment, a size of an object in the first environment, or the like, or any combination thereof. In some embodiments, the point cloud may be in a form of PLY, STL, OBJ, X3D, IGS, DXF. More detailed description of determining the first map may be found elsewhere in the present disclosure, e.g., FIG. 6 and the description thereof.

In 530, the processing engine 112 (e.g., the first map determination module 430 or the interface circuits of the processor 220) may determine a first map based on the first data indicative of the first environment. Firstly, the processing engine 112 may determine feature information associated with the point cloud. The feature information may include point feature information of the set of points, cluster feature information of at least one point cluster corresponding to at least one reference object (e.g., an object with a rod shape, an object with a facet shape). As used herein, the point feature information of a point may represent a relationship between the point and points in a region included the point. In some embodiments, the region may be a sphere centered at the point. The relation may be associated with linearity, planarity, verticality and scattering of the point. Merely by way of example, the point feature information of the point may include a feature value of the point, a feature vector corresponding to the feature value of the point (collectively referred to as “first point feature information”), a linearity of the point, a planarity of the point, a verticality of the point, a scattering value of the point (collectively referred to as “second point feature information”), etc. The processing engine 112 may determine the second point feature information based on the first point feature information. More detailed description of determining the point feature information may be found elsewhere in the present disclosure, e.g., FIG. 6 and the description thereof.

In some embodiments, the processing engine 112 may determine a plurality of point clusters based on the point feature information. Points in each of the plurality of point clusters may satisfy a predetermined condition. Specifically, for each two points in each of the plurality of point clusters, a difference between point feature information of the two points may be smaller than a first predetermined threshold, and a difference between spatial information of the two points may be smaller than a second predetermined threshold. In some embodiments, if a difference of norms of feature vectors of the two points is smaller than the first predetermined threshold, and an included angle of normal vectors associated with the two points is smaller than the second predetermined threshold, it may be considered that the points in each of the plurality of point cluster may satisfy the predetermined condition. As used herein, the processing engine 112 may determine a normal vector associated with a point based on an adjacent region of the point (e.g., a circle centered at the point). The first predetermined threshold and/or the second predetermined threshold may be default settings of the positioning system 100, or may be adjusted based on real-time conditions.

Further, the processing engine 112 may determine the at least one point cluster corresponding to one of the at least one reference object among the plurality of point clusters. In some embodiments, the processing engine 112 may determine a category of each of the plurality of point clusters. The processing engine 112 may determine the category based on a shape of each of the plurality of point clusters. For example, the category may include a rod shape, a facet shape, a shape other than the rod shape and the facet shape. Further, the processing engine 112 may determine the at least one point cluster based on the categories. In some embodiments, a shape of the at least one point cluster may be the rod shape or the facet shape.

In some embodiments, the processing engine 112 may determine the cluster feature information based on point feature information of the at least one point cluster. For illustrated purpose, the cluster feature information of a point cluster may include point feature information of points in the point cluster, a category of the point cluster, an average feature vector of the point cluster, a covariance matrix of each of the point cluster, etc. As used herein, the average feature vector may be an average of point feature vectors of points in the point cluster. More detailed description of determining the cluster feature information may be found elsewhere in the present disclosure. e.g., FIG. 6 and the description thereof.

Further, the processing engine 112 may determine the first map based on the point cloud and the feature information associated with the point cloud. In some embodiments, the processing engine 112 may convert the point cloud into the first map, and the first map may include the feature information associated with the point cloud. In some embodiments, the processing engine 112 may label the first map with at least a portion of the feature information associated with the point cloud. Specifically, the processing engine 112 may use the cluster feature information label the first map. In some embodiments, reference objects of different categories may be marked with different forms, e.g., colors, icons, texts, characters, numbers, etc. For example, the processing engine 112 may label a reference object with a rod shape with a yellow color, and label a reference object with a facet shape with a blue color. As another example, the processing engine 112 may label a reference object with a rod shape with a plurality of small circles, and label a reference object with a facet shape with a plurality of small triangles.

In 540, the processing engine 112 (e.g., the first map determination module 440 or the interface circuits of the processor 220) may determine a target position of the target subject based on the initial position, the first map, and a second map in real-time. As used herein, the second map may include second data indicative of a second environment corresponding to an area including the initial position of the target subject. For example, the area may include a district in a city, a region inside a beltway of a city, a town, a city, etc. In some embodiments, the second map may be predetermined by the positioning system 100 or a third party. The processing engine 112 may obtain the second map from a storage device (e.g., the storage 150), such as the ones disclosed elsewhere in the present disclosure.

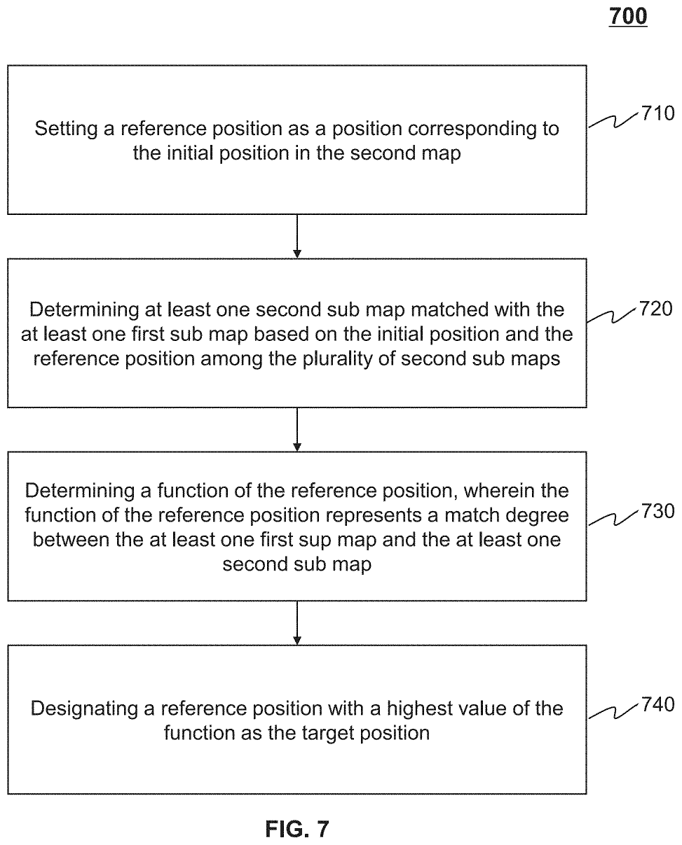

In some embodiments, the processing engine 112 may determine the target position of the target subject by matching the first map and the second map. Specifically, the processing engine 112 may determine a set of at least one second sub map in the second map that match the at least one first sub map based on the initial position. As used herein, each of the at least one second sub map may be a portion of the second map. The processing engine 112 may determine a match degree between each of the set of at least one first sub map and the at least one second sub map. As used herein, the match degree may represent a similarity of the at least one first sub map and the at least one second sub map. In some embodiments, the processing engine 112 may determine a maximum match degree, i.e., at least one second map corresponding to the maximum match degree may match the at least one first sub map best, and the processing engine 112 may designate a position determined by the at least one second map as the target position of the target subject in the second map. Since a positioning accuracy of the second map is more accurate than a positioning accuracy of the GPS/IMU, the processing engine 112 may determine a more accurate position (also referred to as “target position”) of the target subject by matching the first map and the second map based on the initial position. More detailed description of determining the target position of the target subject may be found elsewhere in the present disclosure. e.g., FIG. 7 and the description thereof.

In an application scenario, an autonomous vehicle may be positioned by the positioning system 100 in real-time. Further, the autonomous vehicles may be navigated by the positioning system 100.

In an application scenario, the positioning system 100 may transmit a message to a terminal (e.g., the terminal device 130), to direct the terminal to display the target position of the target subject e.g., on a user interface of the terminal in real-time, thereby facilitating the user to know where the target subject is in real-time.

In an application scenario, the positioning system 100 can determine a target position of the target subject in some places where the GPS signal is weak e.g., a tunnel. Further, the target position of the target subject can be used to provide a navigation service to the target subject.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional steps (e.g., a storing step) may be added elsewhere in the exemplary process 500. In the storing step, the processing engine 112 may store information (e.g., the initial position, the first data, the first map, the second map) associated with the target subject in a storage device (e.g., the storage 150), such as the ones disclosed elsewhere in the present disclosure. As another example, if the first data determined in operation 520 does not include any of the reference object, e.g., an object with a rod shape, an object with a facet shape, operation 530 and operation 540 may be omitted.

FIG. 6 is a flowchart illustrating an exemplary process for determining a first map based on first data indicative of the first environment according to some embodiments of the present disclosure. In some embodiments, the process 600 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations herein discussed. Additionally, the order in which the operations of the process as illustrated in FIG. 6 and described below is not intended to be limiting. In some embodiments, operation 530 of the process 500 may be implemented based on the process 600.

In 610, the processing engine 112 (e.g., the first map determination module 430 or the interface circuits of the processor 220) may determine point feature information of each point in the first point cloud. In some embodiments, the processing engine 112 may determine the point feature information based on the data of the set of points in the point cloud. As described in connection with FIG. 5, the point feature information of a point may represent a relationship between the point and points in a region included the point. The relation may be associated with linearity, planarity, verticality and scattering of the point. Merely by way of example, the point feature information of the point may include a feature value of the point, a feature vector corresponding to the feature value of the point (collectively referred to as “first point feature information”), a linearity of the point, a planarity of the point, a verticality of the point, a scattering value of the point (collectively referred to as “second point feature information”), etc.

In some embodiments, the processing engine 112 may determine the first point feature information of the point based on a Principal Components Analysis (PCA). Further, the processing engine 112 may determine the second point feature information of the point based on the first point feature information of the point. In some embodiments, the processing engine 112 may determine the second point feature information based on Equation (1)-(5) below:

$$\begin{matrix}L = \frac{{λ}_{1} - {λ}_{2}}{{λ}_{1}} & ( 1 ) \\ P = \frac{{λ}_{2} - {λ}_{3}}{{λ}_{1}} & ( 2 ) \\ S = \frac{{λ}_{3}}{{λ}_{1}} & ( 3 ) \\ V = \frac{U [ 3 ]}{\vert U \vert} & ( 4 ) \\ U = {\sum }_{j = 1}^{3} {λ}_{j} {u}_{j} & ( 5 )\end{matrix}$$

wherein λ₁, λ₂, λ₃ refers to three feature values of the point, and the three feature values are sequenced from largest to smallest, L refers to the linearity of the point, P refers to the planarity of the point, S refers to the scattering value of the point, and V refers to the verticality of the point. The processing engine 112 may determine V based on Equation (4), wherein U[3] refers to a feature vector corresponding to λ₃. The processing engine 112 may determine U based on Equation (5), wherein uⱼ refers to an ith feature vector of the point corresponding to an ith feature value of the point.

In 620, the processing engine 112 (e.g., the first map determination module 430 or the interface circuits of the processor 220) may determine a plurality of point clusters based on the point feature information and spatial information of each point in the first point cloud. As described in FIG. 5, each of the plurality of point clusters may include a portion of points in the point cloud that satisfy a predetermined condition. Specifically, for each two points in each of the plurality of point clusters, a difference between feature information of the two points may be smaller than a first predetermined threshold, and a difference between spatial information of the two points may be smaller than a second predetermined threshold. In some embodiments, if a difference of norms of feature vectors of the two points is smaller than the first predetermined threshold, and an included angle of normal vectors associated with the two points is smaller than the second predetermined threshold, it may be considered that the points in each of the plurality of point cluster may satisfy the predetermined condition. As used herein, the processing engine 112 may determine a normal vector associated with a point based on an adjacent region of the point (e.g., a circle centered at the point). The first predetermined threshold and/or the second predetermined threshold may be default settings of the positioning system 100, or may be adjusted based on real-time conditions.

In some embodiments, before determining the plurality of point clusters, the processing engine 112 may filter out at least a portion of the plurality of points in the first point cloud based on the point feature information. Further, the processing engine 112 may determine the plurality of point clusters based on point feature information of each of the filtered points and spatial information of each of the filtered points. In some embodiments, the processing engine 112 may filter out the at least a portion of the plurality of points in the first point cloud based on the point feature information. For example, the processing engine 112 may filter out points with a verticality smaller than a predetermined threshold, e.g., 0.2, 0.3, etc.

In 630, the processing engine 112 (e.g., the first map determination module 430 or the interface circuits of the processor 220) may determine the first map based on the point feature information and the plurality of point clusters. Firstly, the processing engine 112 may determine cluster feature information of each of at least one point cluster corresponding to one of the at least one reference object among the plurality of point clusters. As described elsewhere in the present disclosure, the reference object may have a predetermined shape. Merely by way of example, the predetermined shape may include a rod shape, a faceted shape, etc. The cluster feature information may include point feature information of points in the point cluster, a category of each of the point cluster, an average feature vector of the point cluster, a covariance matrix of each of the point cluster, etc.

Further, as described elsewhere in the present disclosure, the processing engine 112 may determine the first map based on the point cloud, the point feature information and the cluster feature information. In some embodiments, the first map may include the point feature information and the cluster feature information. In some embodiments, the processing engine 112 may convert the point cloud into the first map, and the first map may include the feature information associated with the point cloud. In some embodiments, the processing engine 112 may label the first map with at least a portion of the feature information associated with the point cloud. Specifically, the processing engine 112 may use the cluster feature information label the first map. In some embodiments, objects of different categories may be marked with different forms, e.g., colors, icons, texts, characters, numbers, etc. For example, the processing engine 112 may label an object with a rod shape with a yellow color, and label an object with a facet shape with a blue color. As another example, the processing engine 112 may label an object with a rod shape with a plurality of small circles, and label a facet shape with a plurality of small triangles.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 7 is a flowchart illustrating an exemplary process for determining a target position of a target subject based on an initial position of the target subject, a first map and a second map according to some embodiments of the present disclosure. In some embodiments, the process 700 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting. In some embodiments, operation 540 of the process 500 may be implemented based on the process 700.

In 710, the processing engine 112 (e.g., the second position determination module 440 or the interface circuits of the processor 220) may set a reference position as a position corresponding to the initial position in the second map. The reference position may be unknown, and the processing engine 112 may determine a plurality of solutions of the reference position based on the process 700.

In 720, the processing engine 112 (e.g., the second position determination module 440 or the interface circuits of the processor 220) may determine at least one second sub map matched with the at least one first sub map based on the initial position and the reference position among the plurality of second sub maps. As described elsewhere in the present disclosure, each of the at least one second sub map may be a portion of the second map. Firstly, the processing engine 112 may determine at least one converted first sub map based on the first map, the second map, the initial position, and the reference position. The processing engine 112 may generate the at least one converted first sub map by converting the first sub map into the second map based on the reference position and the initial position. In some embodiments, the processing engine 112 may determine the at least one converted first sub map based on Equation (6)-(8) below:

X=xᵢ(i=0 . . . N−1) (6)

X′=Rxᵢ+t′ (7)

t′=[x,y,z]^{T} (8)

wherein x refers to a set of positions of points in the at least one first sub map, xᵢ refers to an ith position of a point in one of the at least one first sub map, x′ refers to a set of locations of positions in the at least one converted first sub map, R refers to a rotation matrix associated with the first map and the second map. t′ refers to a translation matrix associated with the first map and the second map, and the processing engine 112 may determine t′ based on Equation (8).

In some embodiments, the processing engine 112 may determine a converted average feature vector corresponding to each of the converted first sub map. For one first sub map of the at least one first sub map and a second sub map matched with the first sub map, a category of a reference object corresponding to the second sub map may be the same as a category of a reference object corresponding to the first sub map, and a distance between a converted first sup map corresponding to the first sub map and the second sub map may be smaller than a predetermined distance threshold (e.g., 3 meters).

In 730, the processing engine 112 (e.g., the second position determination module 440 or the interface circuits of the processor 220) may determine a function of the reference position. The function of the reference position may represent a match degree between the at least one first sup map and the at least one second sub map. The higher a value of the function is, the higher match degree between the at least one first sub map and the at least one second sub map may be. In some embodiments, the processing engine 112 may determine the function of the reference position based on Equation (9)-(11) below:

$$\begin{matrix}{ɛ}_{j} = \frac{1}{N} {\sum }_{i = 0}^{N} ( {sem}_{ji} - {p}_{j} ) {( {sem}_{ji} - {p}_{j} )}^{T} & ( 9 ) \\ E ( X , t ) = {\sum }_{j}^{M} {\sum }_{i}^{N - 1} exp \frac{- {( {sem}_{ji}^{′} - {p}_{j} )}^{T} {ɛ}_{j}^{- 1} ( {sem}_{ji}^{′} - {p}_{j} )}{2} & ( 10 ) \\ {{sem}^{′} [ {[ {x}^{′} ]}^{T} , v , s , p , l ]}^{T} & ( 11 )\end{matrix}$$

as described elsewhere in the present disclosure, the processing engine 112 may determine the at least one covariance matrix of the at least one cluster (corresponding to the at least one first sub map). In some embodiments, the processing engine 112 may determine the covariance matrix based on Equation (9), wherein εⱼ refers to the covariance matrix associated with a jth first sub map, N refers to a count of point of the jth first sub map, semⱼᵢ, refers to a vector associated with a position of an ith point in the jth first sub map, and pⱼ refers to an average feature vector of the jth first sub map. Further, the processing engine 112 may determine the function of the reference position based one Equation (10), wherein E(X,t) refers to the function of the reference position, semⱼᵢ′ refers to a vector associated with a position of an ith point in the jth first converted map, N refers to a count of point of the jth first sub map, i.e., the jth first converted map, and M refers to a count of the at least one first sub map.

In some embodiments, the processing engine 112 may determine the values of the function based on a Newton iterative algorithm. In each iteration, the processing engine 112 may determine a value of the function. After the value the function is determined, a solution of the reference position corresponding to the value of the function may be determined. The iteration may end when the maximum value of the function is determined. In some embodiments, the processing engine 112 may determine the values of the function based on Equation (12)-(13) below:

f(t)=−E(X,t) (12)

t_{new}=t−H⁻¹g (13)

wherein f(t) refers to a negative function of the function, t refers to a solution of the reference position in an iteration, t_{new} refers to a solution of the reference position in a next iteration, i.e., an iteration after the iteration, H refers to a Hessian matrix, and g refers to a gradient matrix.

In 740, the processing engine 112 (e.g., the second position determination module 440 or the interface circuits of the processor 220) may designate a solution of the reference position with a highest value of the function as the target position. If a value of the function is highest, the processing engine 112 may consider that the target subject may be at the reference position corresponding to the value of the function on the second map.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a target position of a target subject, comprising:
at least one storage medium including a set of instructions; and
at least one processor in communication with the at least one storage medium, wherein when executing the set of instructions, the at least one processor is directed to:
determine, via a positioning device, an initial position of a target subject in real-time;
determine, via a data capturing device, first data indicative of a first environment associated with the initial position of the target subject;
determine a first map based on the first data indicative of the first environment, wherein the first map includes reference feature information of at least one reference object with respect to the first environment; and
determine a target position of the target subject based on the initial position, the first map, and a second map in real-time, wherein the second map includes second data indicative of a second environment corresponding to an area including the initial position of the target subject.

2. The system of claim 1, wherein the reference object includes an object with a predetermined shape.

3. The system of claim 2, wherein the predetermined shape includes a rod shape, or a faceted shape.

4. The system of claim 1, wherein the first data includes a first point cloud indicative of the first environment, and the first point cloud includes data of a plurality of points, and
to determine a first map based on the first data indicative of the first environment, the at least one processor is further directed to:
determine point feature information of each point in the first point cloud;
determine a plurality of point clusters based on the point feature information and spatial information of each point in the first point cloud; and
determine the first map based on the point feature information and the plurality of point clusters.

5. (canceled)

6. The system of claim 4, wherein to determine a plurality of point clusters based on the point feature information and spatial information of each point in the first point cloud, the at least one processor is further directed to:
filter out at least a portion of the plurality of points in the first point cloud based on the point feature information; and
determine the plurality of point clusters based on point feature information of each of the filtered points and spatial information of each of the filtered points.

7. The system of claim 4, wherein the point feature information of each point in the first point cloud includes at least one of: a feature value of the point, a feature vector corresponding to the feature value of the point, a linearity of the point, a planarity of the point, a verticality of the point, or a scattering value of the point.

8. The system of claim 4, for each two points in each of the plurality of point clusters, wherein:
a difference between point feature information of the two points is smaller than a first predetermined threshold; and
a difference between spatial information of the two points is smaller than a second predetermined threshold.

9. The system of claim 4, wherein to determine the first map based on the point feature information and the plurality of point clusters, the at least one processor is directed to:
determine cluster feature information of each of at least one point cluster corresponding to one of the at least one reference object among the plurality of point clusters; and
determine the first map based on the point feature information, the cluster feature information, and the at least one point cluster.

10. The system of claim 9, wherein to determine cluster feature information of each of at least one point cluster corresponding to one of the at least one reference object among the plurality of point dusters, the at least one processor is directed to:
determine a category of each of the plurality of point dusters based on a classifier;
designate one point duster of the plurality of point clusters as one of the at least one point cluster if a category of the point cluster is a same as a category of one of the at least one reference object; and
determine the cluster feature information of the at least one point cluster.

11. The system of claim 9, wherein the cluster feature information of each of at least one point cluster includes at least one of: a category of the point cluster, an average feature vector of the point cluster, or a covariance matrix of the point cluster.

12. (canceled)

13. The system of claim 11, wherein the reference feature information of the at least one reference object with respect to the first environment includes at least one of: a reference category of the reference object, a reference feature vector of the reference object, or a reference covariance matrix of the reference object, or the at least one processor determines the reference feature information based on the cluster feature information.

14. The system of claim 9, wherein the at least one processor is further directed to:
label the first map with the cluster feature information of each of the at least one cluster.

15. The system of claim 1, wherein the second map includes a plurality of second sub maps corresponding to the at least one reference object, and
to determine a target position of the target subject based on the initial position, the first map, and a second map in real-time, the at least one processor is directed to:
set a reference position as a position corresponding to the initial position in the second map;
determine at least one second sub map matched with at least one first sub map based on the initial position and the reference position among the plurality of second sub maps;
determine a function of the reference position, wherein the function of the reference position represents a match degree between the at least one first sup map and the at least one second sub map; and
designate a reference position with a highest value of the function as the target position.

16. The system of claim 15, for one first sub map of the at least one first sub map and a second sub map matched with the first sub map, wherein:
a category of a reference object corresponding to the second sub map is the same as a category of a reference object corresponding to the first b map, and
a distance between a converted first sup map and the second sub map is smaller than a predetermined distance threshold; wherein the converted first sub map is generated by converting the first sub map into the second map based on the reference position and the initial position.

17. (canceled)

18. The system of claim 1, wherein the positioning device includes a Global Positioning System (GPS) and an Inertial Measurement Unit (IMU).

19. (canceled)

20. The system of claim 18, wherein the initial position includes a location of the target subject and an attitude of the target subject.

21. The system of claim 1, wherein the data capturing device includes Lidar.

22. (canceled)

23. The system of claim 1, wherein the target subject includes an autonomous vehicle or a robot.

24-25. (canceled)

26. A method implemented on a computing device having at least one processor, at least one storage medium, and a communication platform connected to a network, the method comprising:
determining, via a positioning device, an initial position of a target subject in real-time;
determining, via a data capturing device, first data indicative of a first environment associated with the initial position of the target subject;
determining a first map based on the first data indicative of the first environment, wherein the first map includes reference feature information of at least one reference object with respect to the first environment; and
determining a target position of the target subject based on the initial position, the first map, and a second map in real-time, wherein the second map includes second data indicative of a second environment corresponding to an area including the initial position of the target subject.

27-50. (canceled)

51. A non-transitory computer readable medium, comprising executable instructions that, when executed by at least one processor, directs the at least one processor to perform a method, the method comprising:
determining, via a positioning device, an initial position of a target subject in real-time;
determining, via a data capturing device, first data indicative of a first environment associated with the initial position of the target subject;
determining a first map based on the first data indicative of the first environment, wherein the first map includes reference feature information of at least one reference object with respect to the first environment; and
determining a target position of the target subject based on the initial position, the first map, and a second map in real-time, wherein the second map includes second data indicative of a second environment corresponding to an area including the initial position of the target subject
